(19) United States
(12) Patent Application Publication
(10) Pub. No.: US 2018/0161812 A1
(43) Pub. Date: Jun. 14, 2018

(54) System and Method for Controlling Thickness of Coating

(71) Applicants: Hyundai Motor Company, Seoul (KR); Kia Motors Corporation, Seoul (KR)

(72) Inventors: Haseung Seong, Daejeon (KR); Moo Woong Choi, Seoul (KR); Jin Seok Kim, Yongin-si (KR)

(21) Appl. No.: 15/618,319

(22) Filed: Jun. 9, 2017

(30) Foreign Application Priority Data
Dec. 14, 2016 (KR) 10-2016-0170772

(51) Int. Cl. B05D 7/14

(52) U.S. Cl. CPC B05D 7/14

(57) ABSTRACT

A system for controlling a thickness of a coating includes a measuring apparatus that is configured to measure a thickness of a coating that includes an electro deposition layer, a middle coating layer, an upper coating layer, and a coating layer. A control apparatus is configured to determine that the thickness of the coating using measurement information received from the measuring apparatus, to determine whether the coating layer, the upper coating layer, the middle coating layer, and the electro deposition layer fail when the thickness of the coating is beyond a predetermined range, and to control an injection amount of a paint based on a result of determining that the coating layer, the upper coating layer, the middle coating layer, and the electro deposition layer fail.

### CROSS-REFERENCE TO RELATED APPLICATIONS

This application claims priority to and the benefit of Korean Patent Application No. 10-2016-0170772 filed in the Korean Intellectual Property Office on Dec. 14, 2016, the entire contents of which are incorporated herein by reference.

### TECHNICAL FIELD

The present invention relates to a system for controlling a thickness of a coating.

### BACKGROUND

In general, although it rains on an outer surface of components for a vehicle such as a steel plate and plastic materials or the outer surface of components for a vehicle is exposed to sunlight, a coated state thereof may be maintained as it is. In particular, a coating process is performed in order to improve the appearance beauty as well as to prevent corrosion.

The above coating process includes a step of forming an electro deposition layer by electro depositing an outer steel plate of a vehicle, a step of forming a middle coating layer on a surface of the electro deposition layer to bake hardening the middle coating layer, a step of forming an upper coating layer by coating an upper coating layer on a surface of the middle coating layer as a color base, and a step of forming a coating layer by coating a surface of the upper coating layer after setting the upper coating layer.

As described above, a coating formed on the vehicle includes an electro deposition, a middle coating, an upper coating, and a CLEAR. The four coatings are coated by different materials, and have different coating purposes.

In detail, the coating of a vehicle includes four layers having an electro deposition layer, a middle coating layer, an upper coating layer, and a coating layer. In general, thicknesses of respective layers in the coating are changed according to a coating material and characteristics of corresponding coating processes and coating schemes where a thickness of the electro deposition layer is 20 μm, a thickness of the middle coating layer is 35 μm to 4 μm, a thickness of the upper coating layer is 15 μm, and a thickness of the coating layer is 4 μm to 45 μm. If the normal thickness of the coating is maintained, the quality of the coating such as physical property of appearance, rust-proofing, a color may be presented.

Accordingly, a vehicle company periodically confirms whether a normal thickness of the coating is maintained.

In general, the thickness of the coating is measured through ultrasonic wave or current when the coating is completely dried and makes contact into with.

However, in a case of the related art, each time the coating is formed, since the thickness of the coating is measured, it takes a long time, and great manpower is required. Further, since the thickness of the coating is measured in a contact state, it is impossible to measure the thickness of the coating in a state that paint is not dried.

The above information disclosed in this Background section is only for enhancement of understanding of the background of the invention and therefore it may contain information that does not form the prior art that is already known in this country to a person of ordinary skill in the art.

### SUMMARY

The present invention relates to a system for controlling a thickness of a coating, and, in particular embodiments to a system and a method for controlling a thickness of a coating which may measure and control a thickness of a coating formed on a vehicle through a Terahertz wave.

Further, an exemplary embodiment of the present invention provides a system and a method for controlling a thickness of a coating which may measure a thickness of a coating in a non-contact state to control a paint injection amount based on the measured thickness of the coating.

An exemplary embodiment of the present invention provides a system for controlling a thickness of a coating. The system includes a measuring apparatus configured to measure a thickness of a coating including an electro deposition layer, a middle coating layer, an upper coating layer, and a coating layer. A control apparatus is configured to generate the thickness of the coating using measurement information received from the measuring apparatus, to determine whether the coating layer, the upper coating layer, the middle coating layer, and the electro deposition layer fail when the thickness of the coating is beyond a predetermined range to control an injection amount of a paint based on the determination result.

Further, the measuring apparatus may output a Teraherz wave to the coating, and may generate measurement information through a reflection wave reflected from the coating.

The control apparatus may generate a thickness of the electro deposition layer, a thickness of the middle coating layer, a thickness of the upper coating layer, and a clear thickness of the coating layer using the measurement information.

The control apparatus may determine whether a clear thickness of the coating layer is within a first reference range when the thickness of the coating is beyond the predetermined range, and may generate a first control signal to transmit the first control signal to a clear coating device when the clear thickness of the coating layer is beyond the first reference range.

The control apparatus may set a first injection control amount according to the clear thickness, and generates a first control signal including the first injection control amount.

The control apparatus may determine whether the coating layer fails, determine whether a thickness of the upper coating layer is within a second reference range when the coating layer is normal, and generate a second control signal to transmit the second control signal to an upper coating device when the thickness of the upper coating layer is beyond the second reference range.

The control apparatus may set a second injection control amount according to the thickness of the upper coating layer, and may generate a second control signal including the second injection control amount.

The control apparatus may determine whether the upper coating layer fails, may determine whether a thickness of the middle coating layer is within a third reference range when the upper coating layer is normal, and may generate a third control signal to transmit the third control signal to a middle coating device when the thickness of the middle coating layer is beyond the third reference range.

The control apparatus may set a third injection control amount according to the thickness of the middle coating layer, and may generate a third control signal including the third injection control amount.

Another embodiment of the present invention provides a method for controlling a thickness of a coating. A thickness of the coating is generated by measuring a thickness a coating including an electro deposition layer, a middle coating layer, an upper coating layer, and a coating layer. The thickness of the coating is determined within a predetermined range and an injection amount of a clear paint is controlled by determining whether a coating layer fails when the thickness of the coating is beyond a predetermined range. An injection amount of an upper paint is controlled by determining whether the upper coating layer fails when the coating layer is normal. An injection amount of a middle coating layer is controlled by determining whether the middle coating layer fails when the upper coating layer is normal.

Since an exemplary embodiment of the present invention measures a thickness of a coating using a Terahertz wave, the thickness of the coating may be exactly measured.

Further, since the thickness of the coating is measured in a non-contact state, the thickness of the coating may be measured in a state that the paint is not dried. Since a paint injection amount may be controlled based on the measured thickness of the coating, failure of the coating may be minimized.

Further, since the thickness of the coating may be automatically measured, a labor cost may be reduced. Real time total measurement is possible due to measurement automation. A paint injection amount may be reduced by managing quantitative quality.

Meanwhile, other various effects may be directly or indirectly disclosed in the following description of the exemplary embodiment of the present invention. That is, various effects expected according to an exemplary embodiment of the present invention may be disclosed in the following detailed description.

### BRIEF DESCRIPTION OF THE DRAWINGS

FIG. 1 is a block diagram illustrating a system for controlling a thickness of a coating according to an exemplary embodiment of the present invention.

FIG. 2 is a flowchart illustrating a method for controlling a thickness of a coating according to an exemplary embodiment of the present invention.

FIG. 3 is an exemplary diagram illustrating generation of a thickness of a coating according to an exemplary embodiment of the present invention.

FIG. 4 is a graph illustrating a Terahertz wave output on a coating layer and a reflective wave reflected from the coating according to an exemplary embodiment of the present invention.

The following reference numerals can be used in conjunction with the figures
10: electro deposition layer
20: middle coating layer
30: upper coating layer
40: coating layer
50: coating layer
100, 120, 130, 140: coating device
200: coating thickness control system
230: measuring apparatus
250: control apparatus

### DETAILED DESCRIPTION OF ILLUSTRATIVE EMBODIMENTS

Hereinafter, an operation principle with respect to an exemplary embodiment of a system and a method for controlling a thickness of a coating according to the present invention will be described with reference to the accompanying drawings. Following drawings and a detailed description to be described later relate to one of various exemplary embodiments to efficiently describe characteristics of the present invention. Accordingly, the present invention is not limited to following drawings and description.

Further, detailed descriptions of well-known functions and structures incorporated herein may be omitted to avoid obscuring the subject matter of the present invention. Terminologies used in this specification are selected from general terminologies by taking the functions thereof into consideration and they may vary depending on the intentions of operators having ordinary skill in the art. Accordingly, the terminologies used in this specification should be defined based on the substantial meanings thereof and the whole context throughout the present specification.

In addition, the exemplary embodiment may suitably modify, integrate, or separate terms so that those skilled in the art to which the invention pertains can easily understand in order to efficiently describe technical core characteristics of the present invention, but the present invention is not limited thereto.

Hereinafter, an exemplary embodiment of the present invention will be described in detail with reference to the accompanying drawings.

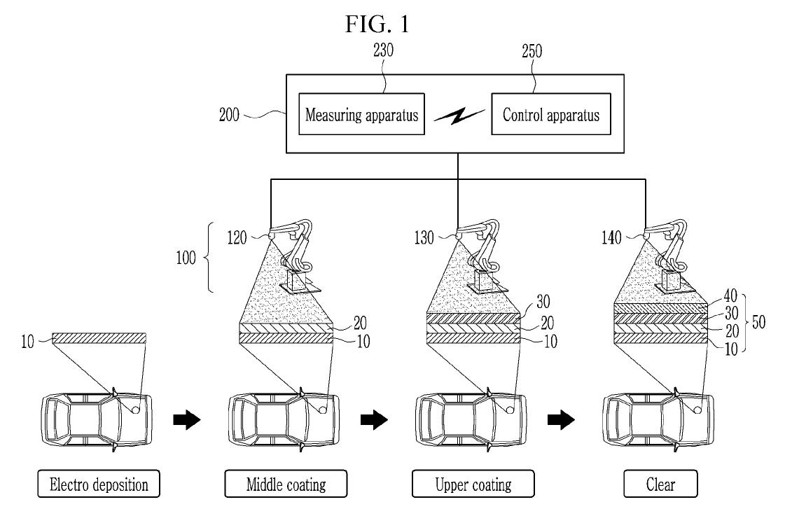

FIG. 1 is a block diagram illustrating a system for controlling a thickness of a coating according to an exemplary embodiment of the present invention.

Referring to FIG. 1, a system 200 for controlling a thickness of a coating according to the present invention is connected with the coating device 100, and controls an injection amount of the coating device 100.

The coating device 100 includes a middle coating device 120, an upper coating device 130, and a clear coating device 140.

The middle coating device 120 forms a middle coating layer 20 on a surface of the electro deposition layer 10 to perform bake hardening the middle coating layer 20. The middle coating device 120 controls an injection amount of a middle layer forming the middle coating layer 20 under control of the system 200 for controlling a thickness of a coating.

The upper coating device 130 coats an upper coating layer on a surface of the middle coating layer 20 as a color base to form the upper coating layer 30. The upper coating device 130 may control an injection amount of an upper paint forming the upper coating layer 300 under the control of the system 200 for controlling a thickness of a coating.

The clear coating device 140 coats a surface of the upper coating layer 30 with a coating material after setting the upper coating layer 30 to form the coating layer 40. The clear coating device 140 may control an injection amount of a clear paint forming the coating layer 40 under the control of the system 200 for controlling a thickness of a coating.

The system 200 for controlling a thickness of a coating includes a measuring apparatus 230 and a control apparatus 250.

The measuring apparatus 230 measures a thickness of a coating 50, which includes the electro deposition layer 10, the middle layer 20, the upper coating layer 30, and a coating layer 40. That is, the measuring apparatus 230 outputs a Terahertz wave to the coating layer 50 and generates measurement information through a reflection wave reflected from the coating 50.

The measuring apparatus 230 transmits measurement information to the control apparatus 250. The measuring apparatus 230 may transmit measurement information to the control apparatus 250 through local area wireless communication. In this case, near field wireless communication may include at least one of Bluetooth, Infrared Data Association (IrDA), Wi-Fi, a Wireless LAN, Radio Frequency (RF), Near Field Communication (NFC), or ZigBee.

The control apparatus 250 generates a thickness of a coating using measurement information, determines whether failure occurs in the coating layer 40, the upper coating layer 30, the middle coating layer 20, and the electro deposition layer 10, respectively, and controls an injection amount of a paint based on the determination result.

In other words, the control apparatus 250 receives measurement information from the measuring apparatus 230 to generate a coating thickness of the coating 50.

The control apparatus 250 determines whether the coating thickness is within a predetermined range. In this case, the predetermined range is a reference range to determine whether the coating thickness is normal or fails, which may be previously set. The predetermined range may be set by a worker or may be set by a predetermined algorithm (e.g., program and probability model).

If the coating thickness is beyond the predetermined range, the control apparatus 250 determines whether the coating layer 40 fails. If the coating layer 40 fails, the control apparatus 250 controls an injection amount of the clear paint.

If the coating layer 40 is normal, the control apparatus 250 determines whether the middle coating layer 30 fails. If the middle coating layer 30 fails, the control apparatus 250 controls an injection amount of an upper paint.

In the upper coating layer 30 is normal, the control apparatus 250 determines whether the upper coating layer 30 fails. If the upper coating layer 30 fails, the control apparatus 250 controls an injection amount of a middle paint.

For the purpose, the control apparatus 250 may be configured by at least one processor operating by a predetermined program. The predetermined program may be programmed to perform respective steps of a method for controlling a thickness of a coating according to an exemplary embodiment of the present invention.

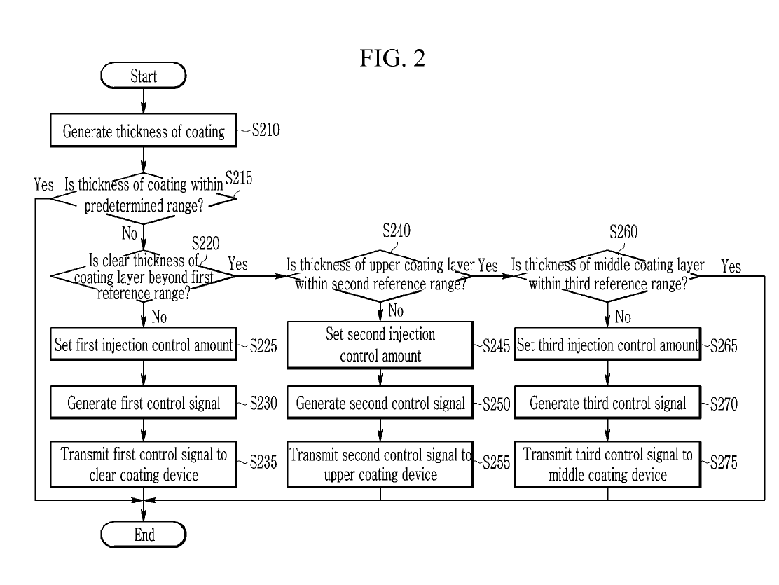

Hereinafter, referring to FIG. 2 to FIG. 4, the method for controlling a thickness of a coating will be described in detail.

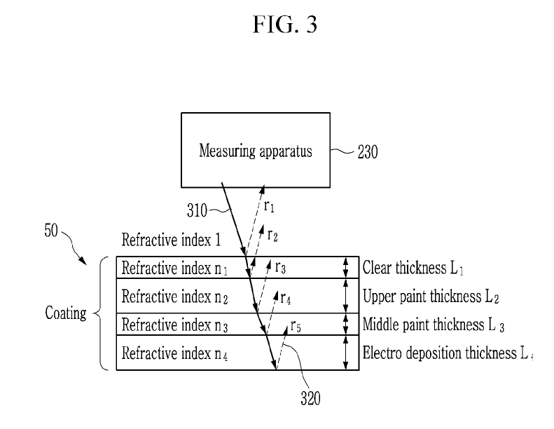

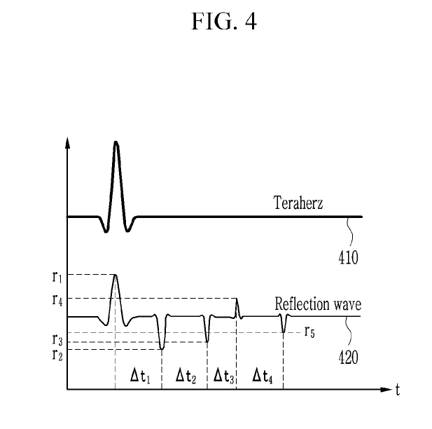

FIG. 2 is a flowchart illustrating a method for controlling a thickness of a coating according to an exemplary embodiment of the present invention, FIG. 3 is an exemplary diagram illustrating generation of a thickness of a coating according to an exemplary embodiment of the present invention, and FIG. 4 is a graph illustrating a Terahertz wave output on a coating and a reflective wave reflected from the coating according to an exemplary embodiment of the present invention.

Referring to FIG. 2, the control apparatus 250 generates a thickness of a coating using measurement information (S210). In detail, as shown in FIG. 3, the measuring apparatus 230 outputs a Teraherz wave 310 to a coating 50 and reflects a reflection wave 620 reflected from the coating 50. In this case, the measuring apparatus 230, as shown in FIG. 3, may detect a first reflection wave r₁ reflected from a surface of the coating layer 40, a second reflection wave r₂ reflected from a surface of the upper coating layer 30, a third reflection wave r₃ reflected from a surface of the middle coating layer 20, a fourth reflection wave r₄ reflected from a surface of the electro deposition layer 10, and a fifth reflection wave r₅ reflected from a surface of the vehicle.

The Teraherz wave 310 may represent a waveform 410 of FIG. 4, and the reflection wave may represent a waveform 420 of FIG. 4.

The measuring apparatus 230 outputs the Teraherz wave, and detects a reflection wave to generate measurement information. The measuring apparatus 230 transmits the generated measurement information to the control apparatus 250.

The control apparatus 250, as shown in FIG. 3, generates a clear thickness L₁, a thickness L₂ of an upper coating layer, a thickness L₃ of a middle coating layer, and a thickness L₄ of an electro deposition layer using the measurement information. That is, the control apparatus 250 may generate thicknesses of layers included in the coating 50 through a following equation 1.

Lₖ=Δtₖ/2×C/nₖ [Equation 1]

where, k represents a constant, and Lₖ may represent a thickness with respect to a k-th layer in the coating 50. In this case, a first layer may represent a coating layer 40, a second layer may represent an upper coating layer 30, a third layer may represent a middle coating layer, and a fourth layer may represent an electro deposition layer 10.

A Δtₖ may represent a difference between a detected time of a k-th reflection wave and a detected time of a (k+1)-th reflection wave, a C may represent a speed of the Teraherz wave, and an nₖ may represent a refractive index of a k-th layer. The Δtₖ may be configured from FIG. 4.

For example, the control apparatus 250 may be converted like [equation 2] in order to a thickness L₁ through [equation 1].

L₁=Δt₁/2×C/n₁ [Equation 2]

where, an L₁ may represents the clear thickness, a Δtₜ may represent a difference between a detected time of a first reflection wave and a detected time of a second reflection wave, a C may represent a speed of the Teraherz wave, and an n₁ may represent a refractive index of the coating layer 40. The Δt₁ may be confirmed from FIG. 4.

The control apparatus 250 may generates a coating thickness of the coating 50 by summing a clear thickness L₁, a thickness L₂ of an upper coating layer, a thickness L₃ of the middle coating layer, and a thickness L₄ of an electro deposition layer, or may generate a thickness of a coating based on an output time of the Teraherz wave and a received time of the reflection wave.

The control apparatus 250 determines whether the thickness of the coating is within a predetermined range (S215).

Meanwhile, if the thickness of the coating is within the predetermined range, the control apparatus 250 terminates control of the thickness of the coating.

If the thickness of the coating is beyond the predetermined range, the control apparatus 250 determines whether a clear thickness of the coating layer 40 is beyond a first reference range (S220). In this case, the first reference range is a reference range to determine whether the clear thickness fails or is normal, and may be a preset range. The first reference range may be set by a worker, or may be set through a predetermined algorithm (e.g., program and probability model).

If the clear thickness is beyond the first reference range, the control apparatus 250 sets a first injection control amount according to the clear thickness (S225). In other words, if the clear thickness is beyond the first reference range, the control apparatus 250 determines whether failure occurs. If clear thickness is less than the first reference range, the control apparatus 250 sets a first injection control amount to increase an injection amount of a thickness with reference to a difference. Further, if the clear thickness exceeds the first reference range, the control apparatus 250 sets a first injection control amount to reduce an injection amount of the thickness with respect to the difference.

The control apparatus 250 generates a first control signal including a first injection control amount (S230). That is, the control apparatus 250 generates the first control signal including a first injection control amount in order to control a clear coating device 140.

The control apparatus 250 transmits the first control signal to the clear coating device 140 (S235). In this case, the clear coating device 140 may receive the first control signal to control an injection amount of a clear paint according to a first injection control amount included in the first control signal.

Meanwhile, if the clear thickness is within the first reference range, the control apparatus 250 determines whether a thickness of the upper coating layer 30 is within a second reference range (S240). In this case, the second reference range is a reference range to determine whether the thickness of an upper coating layer fails or is normal, and may be a predetermined range. The second reference range may be set by a worker, or may be set through a predetermined algorithm (e.g., program and probability model).

If the thickness of the upper coating layer is beyond the first reference range, the control apparatus 250 sets a second injection control amount according to the thickness of the upper coating layer (S245). In detail, if the thickness of the upper coating layer is beyond the second reference range, the control apparatus 250 determines that the thickness of the upper coating layer fails. The control apparatus 250 sets a second injection control amount in order to increase an injection amount of a thickness with respect to a difference when the thickness of the upper coating layer is less than the second reference range. Further, the control apparatus 250 sets a second injection control amount in order to reduce an injection amount of a thickness with respect to a difference when the thickness of the upper coating layer exceeds the second reference range.

The control apparatus 250 generates a second control signal including a second injection control amount (S250).

The control apparatus 250 transmits the second control signal to the upper coating device 130 (S255). Next, the upper coating device 130 receives the second control signal from the control apparatus 250, confirms a second injection control amount based on the second control signal, and controls an injection amount of an upper paint according to the second injection control amount to inject the controlled amount of the upper paint to the vehicle.

Meanwhile, if the thickness of the upper coating layer is within the second reference range, the control apparatus 250 determines whether a thickness of the middle coating layer 20 is within the third reference range (S260). In this case, the third reference range may be a reference range in order to determine whether a thickness of a middle coating layer fails or is normal, and may be a predetermined range. The third reference range may be set by a worker, or may be set through a predetermined algorithm (e.g., program and probability model).

If the thickness of the middle coating layer is beyond the third reference range, the control apparatus 250 sets a third injection control amount according to the thickness of the middle coating layer (S265). In other words, if the thickness of the middle coating layer is beyond the third reference range, the control apparatus 250 determines that the thickness of the middle coating layer fails. The control apparatus 250 sets a third injection control amount in order to increase an injection amount of a thickness with respect to a difference when the thickness of the middle coating layer is less than the third reference range. Moreover, the control apparatus 250 sets a third injection control amount in order to reduce an injection amount of a thickness with respect to a difference when the thickness of the middle coating layer exceeds the third reference range.

The control apparatus 250 generates a third control signal including a third injection control amount in order to control the middle coating device 120 (S270).

The control apparatus 250 transmits the third control signal to the middle coating device 120 (S275). In this case, the middle coating device 120 confirms a third injection control amount through the third control signal received from the control apparatus 250, and controls an injection amount of a middle paint according to the third injection control amount.

Although embodiments of the present invention have been described with reference to a number of illustrative embodiments thereof, it should be understood that numerous other modifications and embodiments can be devised by those skilled in the art that will fall within the spirit and scope of the principles of this disclosure.

What is claimed is:

1. A system for controlling a thickness of a coating, the system comprising:
a measuring apparatus configured to measure a thickness of a coating that includes an electro deposition layer, a middle coating layer, an upper coating layer, and a coating layer; and
a control apparatus configured to determine the thickness of the coating using measurement information received from the measuring apparatus, to determine which of the clear coating layer, the upper coating layer, the middle coating layer, and the electro deposition layer fail when the thickness of the coating is beyond a predetermined range, and to control an injection amount of a paint based on a result of determining which of the clear coating layer, the upper coating layer, the middle coating layer, and the electro deposition layer fail.

2. The system for controlling a thickness of a coating of claim 1, wherein the measuring apparatus is configured to output a Teraherz wave to the coating and to generate measurement information through a reflection wave reflected from the coating.

3. The system for controlling a thickness of a coating of claim 1, wherein the control apparatus is configured to generate a thickness of the electro deposition layer, a thickness of the middle coating layer, a thickness of the upper coating layer, and a clear thickness of the coating layer using measurement information from the measuring apparatus.

4. The system for controlling a thickness of a coating of claim 1, wherein the control apparatus is configured to determine whether a clear thickness of the coating layer is within a first reference range when the thickness of the coating is beyond the predetermined range, and to generate a first control signal and transmit the first control signal to a clear coating device when the clear thickness of the coating layer is beyond the first reference range.

5. The system for controlling a thickness of a coating of claim 4, wherein the control apparatus is configured to set a first injection control amount according to the clear thickness, and to generate the first control signal indicating the first injection control amount.

6. The system for controlling a thickness of a coating of claim 1, wherein the control apparatus is configured to determine whether the coating layer fails, to determine whether a thickness of the upper coating layer is within a second reference range when the coating layer is normal, and to generate a second control signal and transmit the second control signal to an upper coating device when the thickness of the upper coating layer is beyond the second reference range.

7. The system for controlling a thickness of a coating of claim 6, wherein the control apparatus is configured to set a second injection control amount according to the thickness of the upper coating layer, and to generate the second control signal indicating the second injection control amount.

8. The system for controlling a thickness of a coating of claim 1, wherein the control apparatus is configured to determine whether the upper coating layer fails, to determine whether a thickness of the middle coating layer is within a third reference range when the upper coating layer is normal, and to generate a third control signal and transmit the third control signal to a middle coating device when the thickness of the middle coating layer is beyond the third reference range.

9. The system for controlling a thickness of a coating of claim 8, wherein the control apparatus is configured to set a third injection control amount according to the thickness of the middle coating layer, and to generate a third control signal indicating the third injection control amount.

10. A method for controlling a thickness of a coating, the method comprising:
generating a thickness of a coating by measuring a thickness of a coating that includes an electro deposition layer, a middle coating layer, an upper coating layer, and a coating layer;
determining whether the thickness of the coating is within a predetermined range;
controlling an injection amount of a clear paint when determining that a coating layer fails when the thickness of the coating is beyond a predetermined range;
controlling an injection amount of an upper paint when determining that the upper coating layer fails when the coating layer is normal; and
controlling an injection amount of a middle coating layer when determining that the middle coating layer fails when the upper coating layer is normal.

11. The method of claim 10, wherein generating the thickness of the coating comprises:
outputting a Teraherz wave to the coating;
generating measurement information through a reflection wave reflected from the coating; and
generating a thickness of the electro deposition layer, a thickness of a middle coating layer, a thickness of the upper coating layer, a clear thickness of the coating layer, and the thickness of the coating using the measurement information.

12. The method of claim 10, wherein controlling the injection amount of the clear paint comprises:
determining whether a clear thickness of the coating layer is within a first reference range when the thickness of the coating is beyond a predetermined range;
setting a first injection control amount according to the clear thickness when the clear thickness is beyond a first reference range;
generating a first control signal including the first injection control amount; and
transmitting the first control signal to a clear coating device.

13. The method of claim 10, wherein controlling the injection amount of the upper paint comprises:
determining whether a thickness of the upper coating layer is within a second reference range when the coating layer is normal;
setting a second injection control amount according to the thickness of the upper coating layer when the thickness of the upper coating layer is beyond a second reference range;
generating a second control signal including the second injection control amount; and
transmitting the second control signal to an upper coating device.

14. The method of claim 10, wherein controlling the injection amount of the middle coating layer comprises:
determining whether a thickness of the middle coating layer is within a third reference range when the upper coating layer is normal;
setting a third injection control amount according to the thickness of the middle coating layer when the thickness of the middle coating layer is beyond a third reference range;
generating a third control signal including the third injection control amount; and
transmitting the third control signal to a middle coating device.

15. A method comprising:
using a middle coating device to coat a vehicle with a middle coating layer;
using an upper coating device to coat the vehicle with an upper coating layer that overlies the middle coating layer;
using a clear coating device to coat the vehicle with a clear coating layer that overlies the upper coating layer;
measuring a thickness of a coating that includes an electro deposition layer, the middle coating layer, the upper coating layer, and the coating layer;
determining whether or not the thickness of the coating is within a predetermined range;
when the thickness of the coating is within a predetermined range, painting a second vehicle without changing settings of the middle coating device, the upper coating device, or the clear coating device;
when the thickness of the coating is not within the predetermined range, determining whether a thickness of the clear coating layer is within a first reference range;
when the thickness of the coating layer is not within the predetermined range and the thickness of the clear coating layer is not within the first reference range, setting a first injection control amount according to the thickness of the clear coating layer, generating a first control signal including the first injection control amount, and transmitting the first control signal to the clear coating device;
when the thickness of the coating layer is not within the predetermined range and the thickness of the clear coating layer is within the first reference range, determining whether a thickness of the upper coating layer is within a second reference range;
when the thickness of the coating layer is not within the predetermined range, the thickness of the clear coating layer is within the first reference range and the thickness of the upper coating is not within the second reference range, setting a second injection control amount according to the thickness of the upper coating layer, generating a second control signal including the second injection control amount, and transmitting the second control signal to the upper coating device;
when the thickness of the coating layer is not within the predetermined range, the thickness of the clear coating layer is within the first reference range and the thickness of the upper coating is within the second reference range, determining whether a thickness of the middle coating layer is within a third reference range; and
when the thickness of the coating layer is not within the predetermined range, the thickness of the clear coating layer is within the first reference range, the thickness of the upper coating is within the second reference range and the thickness of the middle coating layer is not within the third reference range, setting a third injection control amount according to the thickness of the middle coating layer, generating a third control signal including the third injection control amount, and transmitting the third control signal to a middle coating device.

16. The method of claim 15, wherein measuring the thickness of the coating comprises using a terahertz wave to measure the thickness of the coating.

17. The method of claim 16, wherein measuring the thickness of the coating comprises measuring a thickness of each layer of the coating using an equation
Lₖ=Δtₖ/2×C/nₖ
where k represents an index indicating a k-th layer, Lₖ represents a thickness with respect to a k-th layer in the coating, Δtₖ represents a difference between a detected time of a k-th reflection wave and a detected time of a (k+1)-th reflection wave, C represents a speed of the Teraherz wave, and nₖ represents a refractive index of a k-th layer.

18. The method of claim 16, further comprising measuring the thickness of the clear coating layer prior to determining whether the thickness of the clear coating layer is within the first reference range, measuring the thickness of the clear coating layer comprising:
directing a terahertz wave toward the coating;
calculating a thickness of the clear coating layer using an equation
L₁=Δt₁/2×C/n₁
where L₁ represents the thickness of the clear coating layer, Δt₁ represents a difference between a detected time of a wave reflected from the clear coating layer and a detected time of a wave reflected from the upper coating layer, C represents a speed of the Teraherz wave, and n₁ represents a refractive index of the clear coating layer.
